(19) United States
(12) Patent Application Publication
(10) Pub. No.: US 2020/0054901 A1
(43) Pub. Date: Feb. 20, 2020

(54) Twist And Click Locking Mechanism Of Replaceable Non Symmetrical Filter And Inner Yoke Fitting Part Of Half Mask Face Piece

(71) Applicant: Mahesh KUDAV, Navi Mumbai (IN)

(72) Inventors: Mahesh KUDAV, Navi Mumbai (IN); Srinivas MATLAPUDI, Mumbai (IN)

(21) Appl. No.: 16/476,439

(22) PCT Filed: Jan. 7, 2018
(86) PCT No.: PCT/IN2018/050009

§ 371 Date: Jul. 8, 2019

(30) Foreign Application Priority Data
Jan. 7, 2017 (IN) 201621023333

(51) Int. Cl. A62B 9/04; A62B 23/02

(52) U.S. Cl. CPC A62B 9/04; A62B 18/025; A62B 23/025

(57) ABSTRACT

The invention discloses a respiratory protective device having “Twist and Click” locking mechanism on the threaded circular joint on an inner yoke fitting part of half mask face-piece and replaceable non symmetrical filter, thereby allowing an non symmetrical filter having a non symmetrical geometry to be positioned perfectly, correctly and easily on inner yoke part of mask face-piece with reduced slippage and quick assembly.

### FIELD OF THE INVENTION

The present invention relates, in general to a respiratory protective device and more particularly, to a respiratory protective device having “Twist and Click” locking mechanism on the threaded circular joint on the inner yoke fitting parts of half mask face-piece and replaceable non symmetrical filter, thereby allowing a non symmetrical filter having a non symmetrical geometry to be positioned perfectly, correctly and easily on inner yoke part of mask face-piece with reduced slippage and quick assembly.

### BACKGROUND OF THE INVENTION

In bayonet type trapezoidal locking non symmetrical filter, the non symmetrical filter has to be placed in a particular defined position on inner yoke fitting part of half mask face-piece initially by user and then the replaceable non symmetrical filter is rotated to screw the non symmetrical filter in correct position till the larger or greater area part of the trapezoidal non symmetrical filter is away from the user in an off centre swept back position. The direction of fitting and alignment of the positioning of the replaceable non symmetrical filter has to be studied by laymen or user prior to use.

In such type of non symmetrical filters, the trapezoidal non symmetrical filter has to be placed in a particular position by the user which makes it inconvenient to the user and then rotated, till the non symmetrical filter is fitted at a particular position. The screwing may be too tight or too loose.

In non circular or non symmetrical shape of replaceable filter, it is mandatory to position the non symmetrical filter at a particular position and stop the rotation of the non symmetrical filter at a particular position with respect to the geometry of the face-piece.

Overcoming these drawbacks the present invention describes a locking mechanism of the replaceable non symmetrical filter geometry with threaded circular joint that can be positioned by the user at any start place/position on the threaded circular joint of the inner yoke fitting part of half mask face-piece and then twist it till the end stop position providing a click sensation, an easy and perfect fitting arrangement for the user.

### OBJECT OF THE INVENTION

The object of the invention is to provide an easy “Twist and Click” locking mechanism of the replaceable non symmetrical filter and the inner yoke fitting part of half mask face-piece.

The object of the invention is to provide an easy to use non symmetrical replaceable non symmetrical filters with threaded circular joint that can be placed at any start position by the user on the threaded circular joint of the inner yoke fitting part of half mask face-piece where the replaceable non symmetrical filters will stop at end stop position giving a click sensation and feel of an evident end lock to the user, causing the replaceable non symmetrical filter to be positioned at the right position by the user.

The object of the invention is to provide a non symmetrical filter with threaded circular joint which will provide a leak free locking of the non symmetrical filter with the inner yoke fitting part of half mask face-piece.

Another object of the invention is to prevent slippage of the replaceable non symmetrical filter due to improper locking unless a sufficient force is used by the user himself to disengage it for removal.

### STATEMENT OF INVENTION

The invention states a “Twist and Click” locking arrangement, providing a mechanism where the user can position the threaded circular joint of the non symmetrical replaceable non symmetrical filter at any start position on the threaded circular joint of the inner yoke fitting part of half mask face-piece and twist it till an end position with a sensation making it easy for the user to use it and thereby providing a perfect locking of the non symmetrical filter without chances of slippage and leak free locking.

### SUMMARY OF THE INVENTION

In this particular invention as illustrated in FIG. 3c, the replaceable non symmetrical filters 6 is of non symmetrical geometry with a threaded circular joint 10 on it and there is a threaded circular joint 5 on the inner yoke fitting part 11 of half mask face-piece as illustrated in FIGS. 1a, 1b. The user can place or position the threaded circular joint 10 of the non symmetrical filter 6 at any start position on the threaded circular joint 5 of the inner yoke fitting part 11.

The user can then twist the non symmetrical filter 6 in a clockwise direction to rotate the non symmetrical filter 6, which will cause at least one locking element 4 (Shown in FIG. 3c) present on the at least first rib 8 on the threaded circular joint 10 of the non symmetrical filter 6 to lock into the at least one stopper 1 (Shown in FIGS. 1a, 1b, 1c) of the threaded circular joint 5 of the inner yoke fitting part 11.

The threaded circular joint 5 also consists of at least one gap 2 (As shown in FIG. 1c) where the gaps will lock into the at least one protrusion 3 (Shown in FIG. 3c) present on the at least second rib 9 on the threaded joint 10 of the non symmetrical filter 6.

The locking will give a click and user will feel of an end position to stop twisting the non symmetrical filter giving a confidence to the user of a perfect and proper locking of the non symmetric non symmetrical filter in correct position placing the larger part of the non symmetrical filter in swept back position.

### BRIEF DESCRIPTION OF THE DRAWINGS

FIGS. 1a, 1b, 1c illustrates the different angled view of the inner yoke fitting part of half mask face-piece.

FIG. 2 illustrates a close view of inner yoke fitting part showing at least one gap and the treaded circular joint on the inner yoke fitting part.

FIG. 3a illustrates the isometric view of the replaceable non symmetrical filter.

FIG. 3b illustrates the back view of the replaceable non symmetrical filter.

FIG. 3c illustrates the front view of the replaceable non symmetrical filter.

FIG. 4 and FIG. 4a, illustrates the assembly of non symmetrical filter with inner yolk fitting part.

FIG. 5 and FIG. 5a illustrates the exploded view of the non symmetrical filter and the half mask face piece.

### BRIEF DESCRIPTION OF INVENTION

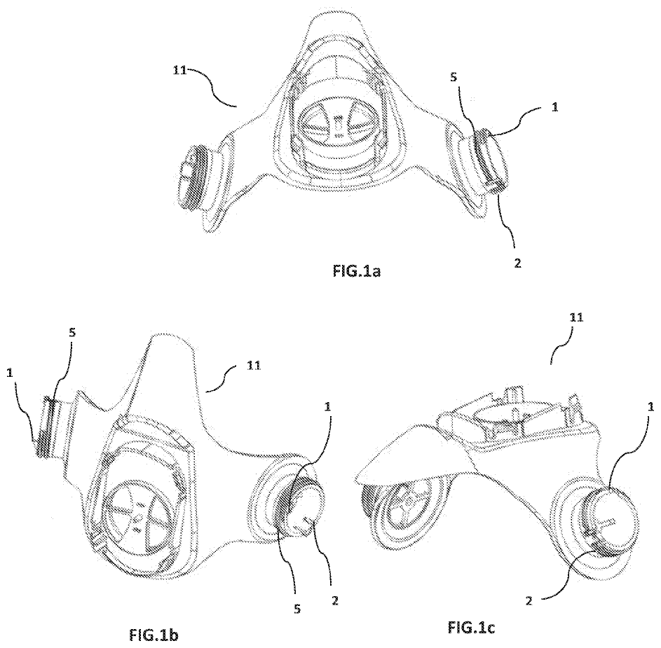

FIGS. 1a, 1b, 1c illustrates the different angled view of the inner yoke fitting part 11 of half mask face-piece.

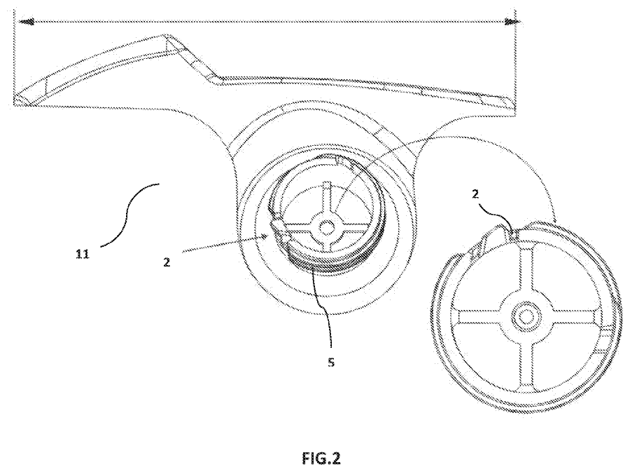

FIG. 2 illustrates a close view of inner yoke fitting part showing at least one gap 2 and the treaded circular joint 5 on the inner yoke fitting part 11.

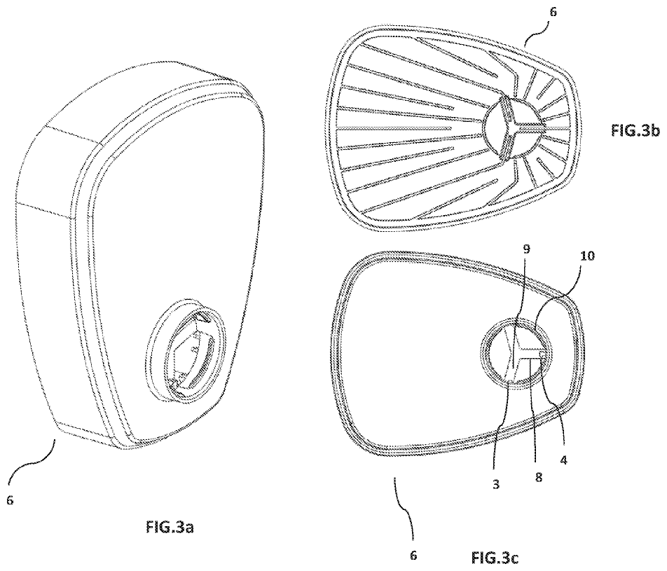

FIG. 3a illustrates the isometric view of the replaceable non symmetrical filter, while FIG. 3b illustrates the back view of the replaceable non symmetrical filter; FIG. 3c illustrates the front view of the replaceable non symmetrical filter.

In this particular invention FIG. 3c illustrates a non symmetrical filter 6 of non-symmetric non symmetrical filter geometry with a threaded circular joint 10, where the user can place the non symmetrical filter 6 with threaded circular joint 10 at any start location/position at any place on the threaded circular joint 5 of the inner yoke fitting part 11 of half mask face-piece as illustrated in FIGS. 1a, 1b, 1c, FIG. 2 as per the user convenience and then rotate it in a circular clockwise direction to lock the non symmetrical filter 6 on the inner yoke fitting part 11 at an end position.

The locking mechanism of twist and click works as explained below.

The threaded circular joint 10 of the non symmetrical filter 6 consists of at least one locking element 4 on the at least first rib 8 (FIG. 3c) and the threaded circular joint 5 on the inner yoke fitting part 11 consists of at least one stopper 1 (FIG. 1b). The at least one locking element 4 of the threaded circular joint 10 stops at the at least one stopper 1 of the threaded circular joint 5 when the non symmetrical filter 6 is rotated in a clockwise direction by the user which stops the non symmetrical filter from further rotation that gives the user a evident feel of an end lock sensation with a click.

The threaded circular joint 5 also consists of at least one gap 2 (FIG. 1b and FIG. 2) which locks in at least one protrusion 3 on the at least second rib 9 (FIG. 3c) of the threaded joint 10 on the non symmetrical filter 6.

FIG. 2 illustrates a close view of inner yoke fitting part showing at least one gap 2 and the threaded circular joint 5 on the inner yoke fitting part 11.

As illustrated in FIG. 1b and FIG. 3C, the non symmetrical filter is twisted till there is locking sensation with click due to locking between the at least one locking element 4 on the threaded circular joint 10 of the non symmetrical filter 6 with the at least one stopper 1 on the threaded circular joint 5 and due to the locking of the at least one gap 2 in the threaded circular joint 5 with the at least one protrusion 3 on the threaded circular joint 10.

Once the non symmetrical filter reaches an end position the user has to stop the twisting of the non symmetrical filter. It gives the confidence to the user of a perfect and proper locking of the non symmetric non symmetrical filter in correct position placing the larger part of the non symmetrical filter in swept back position.

The stopper 1 and the protrusion 3 can be on any of the ribs on the threaded circular joint 10 without limitation of them being on the at least first rib 8 and the at least second rib 9 respectively.

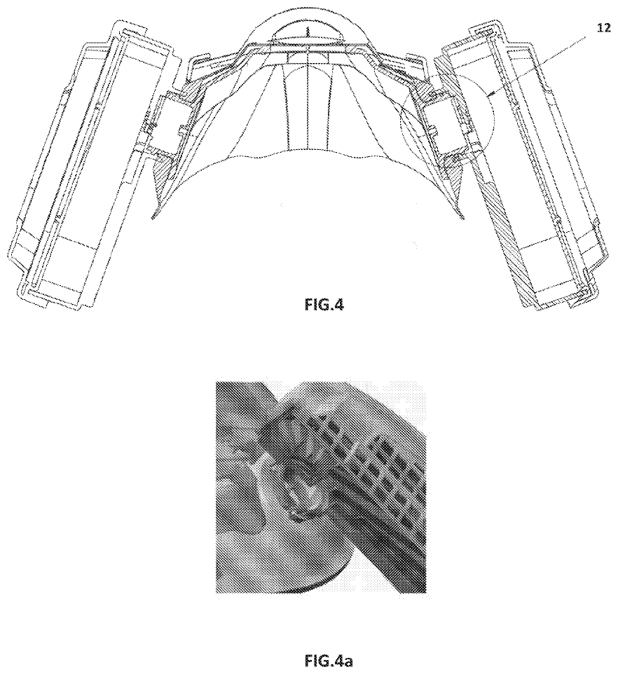

FIG. 4 and FIG. 4a, illustrates the assembly 12 of non symmetrical filter 6 with inner yolk fitting part 11.

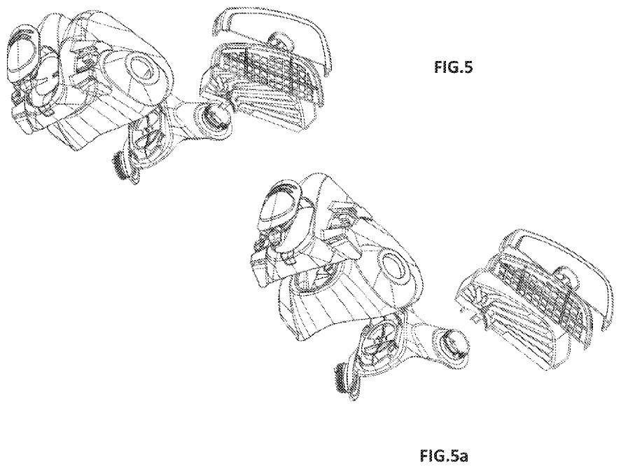

FIG. 5 and FIG. 5a, illustrates the exploded view of the non symmetrical filter and the half mask face piece.

In an embodiment, there can be one non symmetrical filter instead of two non symmetrical filters or more than two non symmetrical filters.

In an embodiment, the non symmetrical filter can be assembled on the inner yolk fitting part of a full mask face piece.

The rotation locks the non symmetrical filter conveniently without any extra effort by the user. The non symmetrical filter cannot go beyond the particular stop end position. It gives resistance when the user unlocks the non symmetrical filter in anticlockwise direction providing a perfect fit. The non symmetrical filter can only be disengaged by force application by the user surcompassing the resistance provided by the lock when the user rotates or twists the non symmetrical filter in an anticlockwise direction.

This mechanism prevents air leakage and slippage of the non symmetrical filter from its locked position on the user face making it hassle free and convenient to place it on the fitting and simple to use.

This type of locking makes it easy for the user to maintain the position of the non symmetrical filter irrespective of the starting position from where the user places it on the inner yoke fitting part to rotate it until the locking end position. This kind of feature on the threaded joint allows locking of the non symmetrical filter in a particular stop position and allowing a perfect fit of the non symmetrical filters with inner yoke fitting part of half mask face-piece respirator ready to wear it. The locking will prevent the non symmetrical filter to come out easily as the fitting shows resistance, unless the wearer himself applies a sufficient force to remove the non symmetrical filter from Inner yoke fitting part of half mask face-piece.

This ensures that the final position of the non symmetrical filter is maintained to suit the face profile irrespective of its initial engagement and start position of the threaded circular joint of the non symmetrical filter with the threaded circular joint of the half mask face-piece inner yoke fitting part. This makes it simple, convenient and easy for the user. It further ensures lock and click gives confidence to the user of leak free engagement.

In an embodiment, as soon as the non symmetrical filter is locked on the fitting there is a click audible sound making it hearable to the user giving the user a signal to stop further rotation of the non symmetrical filter.

In an embodiment, the click can be without an audible sound giving the user an evident end feel to stop further rotation of the non symmetrical filter.

The device can be of multiple materials, multiple dimensions.

We claim:

1) A half mask face piece comprising of a twist and click locking mechanism wherein an user can place a replaceable non symmetrical filter with a threaded circular joint having a non symmetrical filter geometry at any start location/position at any place on a threaded circular joint of an inner yoke fitting part of the half mask face-piece and twist or rotate the non symmetrical filter in a circular clockwise direction to lock the non symmetrical filter on the threaded circular joint of the inner yoke fitting part at an end position till it clicks giving the user an evident lock feel.

2) A half mask face piece as claimed in claim 1, wherein an at least one locking element on the threaded circular joint of the non symmetrical filter locks with an at least one stopper on the threaded circular joint of the inner yoke fitting part.

3) A half mask face piece as claimed in claim 1, wherein an at least one protrusion on the threaded circular joint of the non symmetrical filter locks with an at least one gap on the threaded circular joint of the inner yoke fitting part.

4) A half mask face piece as claimed in claim 1, wherein the locking makes it easy for the user to maintain the position of the non symmetrical filter irrespective of the start position from where the user places it on the inner yoke fitting part to twist or rotate it until the locking end position.

5) A half mask face piece as claimed in claim 1, wherein the locking will prevent the non symmetrical filter to come out easily as the fitting shows resistance, unless the wearer himself applies a sufficient force to remove the non symmetrical filter from inner yoke fitting part of half mask face-piece.

6) A half mask face piece as claimed in claim 1, wherein the twist and click mechanism gives confidence to the user of leak free engagement and perfect and proper locking of the non symmetrical filter in correct position placing the larger part of the non symmetrical filter in swept back position.

7) A half mask face piece as claimed in claim 1, wherein final position of the non symmetrical filter is maintained to suit the face profile irrespective of its initial engagement and start position of the threaded circular joint of the non symmetrical filter with the threaded circular joint of the half mask face-piece inner yoke fitting part.

8) A half mask face piece as claimed in claim 1, wherein the non symmetrical filter is positioned perfectly, correctly and easily on the inner yoke part of mask face-piece with reduced slippage and quick assembly.

9) A half mask face piece as claimed in claim 1, wherein the locking gives the user an evident feel of an end lock sensation with a click.
